(19) United States
(12) Patent Application Publication
(10) Pub. No.: US 2026/0093103 A1
(43) Pub. Date: Apr. 2, 2026

(54) Absolute Coordinate Pathology Slide Scanning

(71) Applicant: IRON MOUNTAIN INCORPORATED, Portsmouth, NH (US)

(72) Inventor: William J. Allen, Corvallis, OR (US)

(73) Assignee: IRON MOUNTAIN INCORPORATED, Portsmouth, NH (US)

(21) Appl. No.: 18/902,404

(22) Filed: Sep. 30, 2024

(51) Int. Cl. G02B 21/36; G02B 21/34; G06V 20/69

(52) U.S. Cl. CPC G02B 21/365; G02B 21/34; G02B 21/361; G06V 20/693

(57) ABSTRACT

A digital pathology system receives, via a user interface, a selection of a location in a camera view of a slide captured by the slide scanning device, the selected location in the camera view depicting a location of interest (LOI) on the slide The digital pathology system detects two or more fiducials of the slide depicted in the camera view. The digital pathology system generates, based on locations within the camera view of the two or more detected fiducials, a primary coordinates system (PCS). The digital pathology system determines, using the PCS, coordinates defining the location selected in the camera view, wherein the coordinates define a position of the LOI on the slide. The digital pathology system displays, in the camera view responsive to receiving the selection, the determined coordinates.

### TECHNICAL FIELD

This disclosure generally relates to techniques for digital coordinate systems in microscope slide pathology. More specifically, but not by way of limitation, this disclosure relates to providing a coordinate system for use in an image of a slide that is constructed from inherent fiducials of the microscope slide detected in the image.

### BACKGROUND

Conventional coordinate systems for microscopic slide analysis are generally located on a stage of a microscope and vary according to the specific instrument/model. Even on a single microscope unit, a single location on a slide may appear in a different location in the instrument-specific coordinate plane depending on how the user physically registers (e.g., prepares and positions) the slide to the stage. Such conventional mechanical coordinate system solutions are therefore not useful for viewing the same slide in multiple microscopes or even on the same microscope if the slide is removed and then re-registered. Further, conventional digital coordinate systems (e.g., a pixel coordinate system in a captured image of a slide) are specific to each captured image of the slide.

### SUMMARY

The present disclosure describes techniques for providing an absolute digital coordinate system for digital-image-based slide analysis by detecting fiducials inherent to a slide. A digital pathology system receives, via a user interface, a selection of a location in a camera view of a slide captured by the slide scanning device, the selected location in the camera view depicting a location of interest (LOI) on the slide The digital pathology system detects two or more fiducials of the slide depicted in the camera view. The digital pathology system generates, based on locations within the camera view of the two or more detected fiducials, a primary coordinates system (PCS). The digital pathology system determines, using the PCS, coordinates defining the location selected in the camera view, wherein the coordinates define a position of the LOI on the slide. The digital pathology system displays, in the camera view responsive to receiving the selection, the determined coordinates.

Various embodiments are described herein, including methods, systems, non-transitory computer-readable storage media storing programs, code, or instructions executable by one or more processing devices, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment for generating a primary coordinate system (PCS) for digital-image-based analysis of a slide based on two or more fiducials of the slide detected within an image of the slide and generating coordinates for a location of interest (LOI) on the slide selected in the image based on the PCS, according to certain embodiments disclosed herein.

FIG. 2 depicts a method for generating a primary coordinate system (PCS) for digital-image-based analysis of a slide based on two or more fiducials of the slide detected within an image of the slide and generating coordinates for a location of interest (LOI) on the slide selected in the image based on the PCS, according to certain embodiments disclosed herein.

FIG. 3 depicts an example of a computing system that performs certain operations described herein, according to certain embodiments disclosed herein.

FIG. 4 depicts an example of a cloud computing system that performs certain operations described herein, according to certain embodiments disclosed herein.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The words “exemplary” or “example” are used herein to mean “serving as an example, instance, or illustration. ” Any embodiment or design described herein as “exemplary” or “example” is not necessarily to be construed as preferred or advantageous over other embodiments or designs.

In conventional microscopy, a microscope stage is configured with a coordinate system and a user of the microscope prepares a slide and manually registers it to the stage. While viewing the registered slide via the microscope, the user may then identify a point or region of interest on the slide in view of the instrument-specific coordinates that are visible on the stage underneath and/or around the slide. However, because conventional coordinate systems are configured on the microscope stage itself, they vary according to the microscope instrument/model. Also, even for a single microscope instrument/model, coordinates for a point of interest on a slide can vary on how the user registers the slide in the microscope stage. Such conventional mechanical coordinate system solutions are therefore not repeatable for viewing the same slide in multiple microscopes or even on the same microscope if the slide is removed and then re-registered by the same user or another user. Also, in conventional microscopy, a slide can also be examined via digital images captured of the slide. However, conventional digital coordinate systems (e.g. a pixel coordinate system in a captured image of a slide) are specific to each captured image of the slide because such coordinate systems vary based on camera positioning during image capture in addition to slide positioning. Therefore, conventional image-specific coordinate systems are not useful for examining the same slide in multiple images of the slide.

Certain embodiments described herein address the limitations of conventional microscopy systems by detecting two or more fiducials of a slide in an image of the slide and establishing a primary coordinate system for the image of the slide based on the detected two or more fiducials. Fiducials comprise points or regions on the slide that are detectible in an image or camera view of the slide and can be used as reference point(s) for establishing a primary coordinate system for locating one or more locations of interest (LOIs) on the slide viewed in the image or camera view. Because the primary coordinate system is generated from fiducials that are inherent to the slide, the primary coordinate system can be recreated from any image of the slide and will provide absolute coordinates for LOIs even when the same slide is viewed with another scanning device (e.g., microscope), if the same slide is registered in a different manner (e.g., a change in position/alignment) on the same scanning device, or if the camera position/angle varies in the image captured of the slide. Accordingly, the methods and devices provided herein provide a slide with one or more inherent fiducials and a method for generating an absolute primary coordinate system that enables definition of coordinates of LOIs on the slide. The coordinates provided herein are not image specific. In other words, the coordinates provided herein are not dependent on maintaining a specific camera position/angle in image captures of the slide. Also, the coordinates provided herein are not device-specific coordinate systems and can be used when viewing the slide from multiple different slide scanning devices. Further, the coordinates provided herein are not instance specific, that is, the coordinates provided herein do not vary based on the positioning and alignment of the slide on the scanning device.

The following non-limiting example is provided to introduce certain embodiments. In certain embodiments, a digital pathology system receives, via a user interface, a selection of a LOI on a slide in a camera view of the slide. For example, a slide scanning device captures the camera view or image of the slide that is registered to the slide scanning device. For example, a user registers the slide to a slide scanning device (e.g., a microscope) and a camera/scanning module of the slide scanning device captures a live camera view or an image of the slide. In some instances, the user interface is part of the slide scanning device. In some instances, the user interface corresponds to a computing device separate from but communicatively coupled to the slide scanning device, for example, a mobile computing device that communicates with the slide scanning device and displays a camera view of the slide scanning device. In some instances, a user captures an image or a live camera view of the slide via the slide scanning device and causes the slide scanning device (or mobile computing device) to transmit the image or the live camera view via a network to a computing device associated with another user. In this example, the computing device associated with the other user receives the captured image or the live camera view and displays the captured image or the live camera view via a user interface. In this example, the other user, via a user interface of the other computing device, selects and/or otherwise defines a LOI on the slide in the captured image or in the live camera view. In this example, the digital pathology system receives, from the other computing device, the selection or definition of the LOI on the slide using the captured image or the live camera view.

In certain embodiments, responsive to receiving the selection of the LOI on the slide in the camera view or in the captured image of the slide, the digital pathology system identifies, in the image or the camera view, two or more fiducials of the slide. For example, the fiducials can be one or more corners of the slide identifiable in the image or in the live camera view of the slide. In some instances, a fiducial can be a feature of the slide (e.g., a mark, an indentation) or a feature of a cover element (e.g., a corner of or marking of a cover glass) affixed to the slide that is identifiable in the image. In some instances, a fiducial can be a feature of a specimen on the slide. Fiducials of the slide detected in the image or in the camera view can provide a basis for generating a primary coordinates system for defining one or more LOIs on the slide. In some instances, the digital pathology system applies one or more machine learning models (e.g., image feature recognition models) to the image or to a frame of the live camera view to identify the fiducials. For example, for fiducials comprising a corner of the slide, the digital pathology system can apply a corner recognition model to the image or to the frame of the live camera view to identify corner(s) of the slide detected in the image or in the live camera view. In some instances, for fiducials providing particular markings on a slide, the digital pathology system can apply an object recognition model to the image or to the frame of the live camera view to recognize fiducials comprising the particular markings. In some instances, the digital pathology system detects or otherwise determines two or more fiducials of the slide that are suitable for determining a precise anchor point for determining a primary coordinate system (PCS).

In certain embodiments, the digital pathology system determines a primary coordinate system for the camera view or captured image of the slide based on the two or more fiducials detected in the image or in the camera view. Determining the primary coordinate system (PCS) can involve determining an origin (e.g. anchor point) for x and y axes of the PCS and a scale for the x and y axes of the PCS, based on the detected two or more slide fiducials in the image. In some instances, the digital pathology system determines distance offsets (x, y) from an anchor point and a rotational offset (θ) of each pixel of a sampling pixel grid of a scanned region of interest within the camera view of the slide or captured in an image of the camera view. In some instances, the digital pathology system associates the coordinates for each pixel of the region of interest as metadata within the camera view of the slide or as metadata within an image of the camera view of the slide. In some instances, each pixel of the current camera view (or each pixel of a captured image of the current camera view of the slide) is associated with a respective coordinate defined by respective x and y offsets and respective rotational offset θ determined from the PCS.

In certain embodiments, the digital pathology system defines coordinates for the LOI on the slide in accordance with the determined primary coordinate system. In some instances, the digital pathology system identifies a pixel associated with the LOI on the slide viewed in the image/camera view. For example, the pixel defines an LOI comprising a point on the slide. In some instances, the LOI comprises an area on the slide (e.g. rectangular area, a circular area) depicted by multiple pixels in the image or camera view of the slide. For example, the LOI comprising a rectangular area on the slide can be defined by coordinates associated with a first pixel depicting a corner of a rectangular area LOI and coordinates associated with a second pixel depicting an opposite corner of the rectangular area LOI. For example, the LOI comprising a circular area on the slide can be defined by a pixel depicting a center of a circular area LOI and a set of pixels depicting the circular area LOI falling within a radius of the center. In some instances, the digital pathology system accesses the metadata associated with the image or camera view depicting the LOI on the slide and determines the absolute coordinates of one or more of the one or more pixels within the image or camera view depicting the LOI. For example, the coordinates in the PCS of a pixel defining the LOI comprise x, y offsets of x=−3 cm, y=+4 cm, and a rotational offset of θ=+2 degrees. In some instances, the coordinates of defining the LOI on the slide can define an exact location on the physical slide corresponding to the pixel in the camera view or image of the slide.

In certain embodiments, the digital pathology system displays, in user interface (e.g. in the camera view or in the captured image), the determined coordinates for the LOI on the slide responsive to receiving the selection of the LOI depicted in the image or camera view via the user interface. In some instances, the digital pathology system displays the determined coordinates for the LOI in the camera view of the slide responsive to receiving the selection of the LOI as depicted in the camera view. In some instances, the digital pathology system displays the determined coordinates for the LOI in an image of the slide responsive to receiving the selection of the LOI in the image.

Generating the PCS from an image or camera view of the slide using two or more fiducials of the slide detected in the image or camera view, enables an entity (e.g. a person or a computing system) examining the image or camera view to retrieve absolute coordinates of an LOI encountered on the slide as selected in the image or camera view. As previously discussed, in conventional systems, coordinates are configured on the microscope stage itself and, therefore, the coordinates vary based on how the user registers the slide (e.g. the position and alignment of the slide with respect to the stage coordinates). Such conventional coordinates are therefore not absolute coordinates. On the other hand, the absolute coordinates generated using the methods described herein do not vary based on the microscope or camera instruments used to view the slide nor do they vary based on how the user registers a slide, significantly improving an accuracy of the coordinates generated using the methods described herein compared to conventional coordinate systems, which do vary based on the instruments used and also on how the slide is registered.

The embodiments described herein, specifically generating, based on two or more fiducials of a slide detected in an image or camera view of the slide, a primary coordinates system (PCS), which can be used to define one or more locations of interest (LOIs) on the slide, provides absolute coordinates for the LOIs on the slide. These absolute coordinates do not vary according to the microscope instrument/model used, according to how the user positions the slide during registration, or according to how the image of a slide is captured, as occurs in conventional microscopy systems. By generating the PCS (defining locations in terms of x, y offsets and a rotational offset from an anchor point) for a captured image (or camera view) of a slide as described herein and associating PCS coordinates as metadata of the captured image (or camera view) of the slide, the digital pathology system enables determination of a precise absolute location of a LOI (e.g. a point or an area) on the slide responsive to receiving a selection of (or a definition of) the LOI as viewed in the image or camera view of the slide. Accordingly, the method for PCS coordinates described herein can be used across multiple captured images of a slide without any sacrifice in the fidelity of LOI coordinates.

### Example Operating Environment for Providing an Primary Coordinate System for Digital-Image-Based Slide Analysis Via a Slide Configured With an Optically-Revealable Pervasive Location Fiducial Pattern

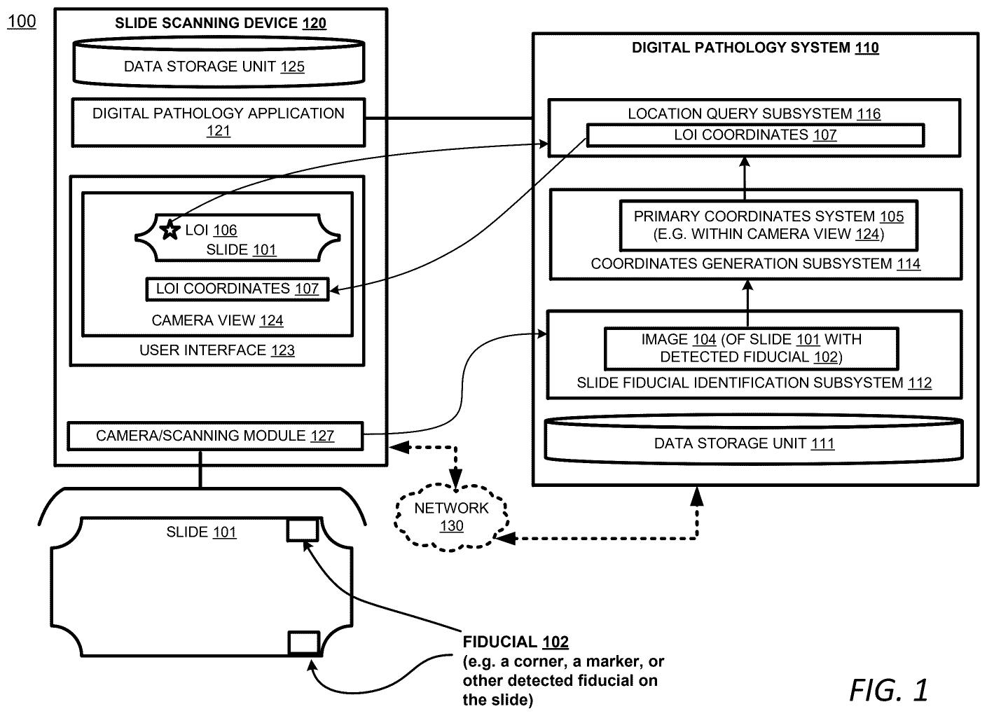

Referring now to the drawings, FIG. 1 depicts an example of a computing environment 100 for generating a primary coordinate system (PCS) 105 for digital-image-based analysis of a slide 101 based on two or more fiducials 102 of the slide 101 detected within an image 104 of the slide 101 and generating coordinates 107 for a location of interest (LOI) 106 on the slide 101 selected in the image 104 based on the PCS 105. In certain embodiments, the computing environment 100 includes a slide scanning device 120 and the digital pathology system 110, including a slide fiducial identification subsystem 112, a coordinates generation subsystem 114, and a location query subsystem 116, is a component of a digital pathology application 121 that executes on the slide scanning device 120. In certain embodiments, the computing environment 100 includes the slide scanning device 120 and the digital pathology system 110 that communicates via a network 130 with the slide scanning device. In certain embodiments, each of the slide fiducial identification subsystem 112, a coordinates generation subsystem 114, and a location query subsystem 116 is a network server or other computing device connected to a network 130.

In certain embodiments, the slide fiducial identification subsystem 112 receives one or more images 104 of a slide 101 captured by a slide scanning device 120. In certain examples, the one or more images of the slide 101 comprise a live camera view 124 including multiple frames which capture slide 101. In some instances, the slide fiducial identification subsystem 112 applies one or more machine learning models and/or object recognition algorithms to the received one or more images 104 of the slide 101 to detect two or more fiducials 102 of the slide. For example, a fiducial 102 of the slide can be a corner of the slide 101, a corner of a cover of the slide, a marking on the slide and/or cover, or other fiducial 102 identifiable on the slide in the one or more images 104 of the slide 101.

In certain embodiments, the coordinates generation subsystem 114 generates a primary coordinates system (PCS) 105 for the image 104 or camera view 124 based on the detected two or more fiducials 102. For example, the coordinates generation subsystem 114 Determining the PCS 105 can involve determining, based on the detected two or more slide fiducials 102 in the image 104 or camera view 124, an origin (e.g. anchor point) for x and y axes of the PCS 105 and a scale for the x and y axes of the PCS 105. In some instances, the coordinates generation subsystem 114 determines distance offsets (x, y) from the origin and a rotational offset (θ) of each pixel of a sampling pixel grid of a scanned region of interest within the camera view 124 or image 104 of the slide 101. For example, the image 104 or camera view 124 depicts a slide and a background environment around the slide and the scanned region of interest within the camera view 124 or the image 104 comprises an area within the camera view 124 or within the image 104 depicting the slide 101 and not the background. In some instances, the coordinates generation subsystem 114 associates the coordinates for each pixel of the sampling pixel grid or the region of interest as metadata within the camera view 124 of the slide or as metadata within the image 104 depicting the slide 101. In some instances, each pixel of the current camera view 124 or of the image 104 is associated with respective coordinates defined as respective x and y offsets from the origin (e.g. anchor point) and respective rotational offset θ using the PCS 105. In some instances, the coordinates generation subsystem 114 generates the PCS 105 responsive to receiving a selection of an LOI 106 on the slide in the camera view 124 or in the image 104. In some instances, the coordinates generation subsystem 114 generates the PCS 105 prior to receiving a selection of an LOI 106 on the slide in the camera view 124 or in the image 104.

In certain instances, the location query subsystem 116 receives, a selection via the user interface 123 in the image 104 or in the live camera view 124, of a location of interest (LOI) 106 on the slide 101. For example, the user of a slide scanning device 120 with which the user captures the image 104 of the slide 101 or through which the user is viewing the live camera view 124 of the slide 101 provides an input to the user interface 123 indicating the LOI 106 on the slide 101 in the captured image 104 or in the live camera view 124. For example, the user clicks, touches, or otherwise interacts with the user interface 123 of the slide scanning device 120 to indicate the LOI 106 on the slide 101 depicted in the image 104 or in the live camera view 124 of the user interface 123. The location query subsystem 116 determines a location defined in terms of the PCS 105 generated by the coordinates generation subsystem 114. For example, the location query subsystem 116 identifies a pixel of the image 104 or of the live camera view 124 associated with the selected LOI 106 and determines, based on the PCS 105, coordinates 107 for the LOI 106 as defined by the PCS 105. For example, the LOI coordinates 107 could include x and y offsets and a rotational offset defining the absolute location of the LOI 106 on the slide 101. In certain embodiments, the slide scanning device 120, responsive to receiving a selection of a LOI 106 in the camera view 124 or within the image 104, displays, via the user interface 123, the LOI coordinates 107 determined by the location query subsystem 116 in the camera view 124 or in the image 104, respectively.

The digital pathology system 110 includes a data storage unit 111. An example data storage unit 111 is accessible to the digital pathology system 110 and stores data for the digital pathology system 110. In some instances, the data storage unit 111 stores an image 104 of a slide 101 captured by the slide scanning device 120. In some instances, the image 104 comprises a frame of a camera view 124 (e.g. video) that the slide scanning device 120 captures of the slide 101. In some instances, the data storage unit 111 stores the PCS 105 generated by the coordinates generation subsystem 114. For example, the PCS 105 defines, for each pixel of a set of pixels of the image 104 depicting the slide 101, absolute coordinates defining locations on the slide 101. In some instances, the data storage unit 111 stores the PCS 105 generated for the image 104 as metadata of the image 104.

An example slide scanning device 120 includes a camera/scanning module 127, a user interface 123, a digital pathology application 121, and a data storage unit 125. In certain embodiments, the slide scanning device 120 is a microscope device. In certain embodiments, the slide scanning device 120 is a smart phone device, a personal computer (PC), a tablet device, or other user computing device. In some embodiments, the slide scanning device 120 communicates with the digital pathology system 110 via the network 130. In some embodiments, the digital pathology system 110 is a component of the digital pathology application 121.

The digital pathology application 121, in some embodiments, is associated with the digital pathology system 110 and the user downloads the digital pathology application 121 on the slide scanning device 120. For example, the user accesses an application store or a website of the digital pathology system 110 using the slide scanning device 120 and requests to download the digital pathology application 121 on the slide scanning device 120. The digital pathology application 121 operates on the slide scanning device 120 and enables a user of the slide scanning device 120 to examine a slide 101. Examining the slide 101 can include zooming in and out using a camera/scanning module 127 to view the slide 101 in a camera view 124 of the user interface 123, capturing one or more images of the slide 101 using the camera/scanning module 127, and/or selecting an LOI 106 on slide 101 depicted in the camera view 124. The digital pathology application 121 can communicate with the user interface 123 to receive one or more inputs from the user. The digital pathology application 121 can instruct the user interface 123 to display a camera view 124 of the slide 101 or an image 104 captured of the slide 101. In some embodiments, the digital pathology application 121 communicates with one or more of the slide fiducial identification subsystem 112, the coordinates generation subsystem 114, the location query subsystem 116, or the data storage unit 111 of the digital pathology system 110. In certain embodiments, the digital pathology application 121 includes the slide fiducial identification subsystem 112, the coordinates generation subsystem 114, the location query subsystem 116 and performs the operations described herein as being performed by the subsystems 112, 114, and 116.

The user interface 123 can include a touchscreen display interface, a display device (e.g. a monitor) with a separate input device (e.g. a mouse), or other user interface 123 which can receive one or more inputs from the user and display information or provide other output to the user. For example, the user interface 123 can display a camera view 124 of an environment including the slide 101 (e.g. a view of a stage of the microscope to which the slide 101 is registered) captured by the camera/scanning module 127. In some instances, the user interface 123 receives one or more inputs from the user, in some instances, instructing the digital pathology application 121 to change the camera view 124 (e.g. zoom in or out, change a camera position or viewing angle), capture one or more images 104 of the slide 101, select an LOI 106 on the slide 101 as depicted in the image(s) 104 or camera view 124 captured by the camera/scanning module 127, and/or to request and then display coordinates 107 for the selected LOI 106.

The data storage unit 125 is accessible to the slide scanning device 120 and stores data for the slide scanning device 120. In some instances, the data storage unit 125 stores one or more images 104 captured by the camera/scanning module 127. In some instances, the slide scanning device 120 stores the PCS 105 generated by the coordinates generation subsystem 114. In some instances, the PCS 105 is associated with a captured image 104 of the slide as metadata of the captured image 104. In some instances, in which the digital pathology system 110 is separate from the slide scanning device 120, the data storage unit 125 is accessible to the digital pathology system 110 via the network 130. For example, the digital pathology system 110 can access data stored in the data storage unit 125 via the network 130.

As depicted in FIG. 1, the user of the slide scanning device 120 positions a slide 101 for viewing via the slide scanning device 120. As depicted in FIG. 1, the camera/scanning module 127 can capture an image 104 and/or provide a camera view 124 of the slide 101. In certain examples, the user identifies a location of interest (LOI) 106 on the slide 101 viewed in the image 104 or the camera view 124 and selected the LOI 106 in the image 104 or in the camera view 124. Responsive to receiving the selection, in the image 104 or in the camera view 124, of the LOI 106 on the slide 101, the coordinates generation subsystem 114 generates a PCS 105 for the image or the camera view 124. In some instances, the coordinates generation subsystem 114 generates the PCS 105 for the image 104 or the camera view 124 and the location query system 116 receives the selection of the LOI 106 subsequent to the generation of the PCS 105. The location query subsystem 116 determines coordinates 107 for the selected LOI 106 based on the generated PCS 105. In certain examples, the LOI 106 comprises a point or region on a sample being examined on the slide 101. In some instances, as depicted in FIG. 1, responsive to the user selecting, within the camera view 124, the LOI 106 on the slide 101, the slide scanning device 120 displays, in the camera view 124, coordinates 107 determined by the location query subsystem 116 for the selected LOI 106 and displays the coordinates 107 in the camera view 124. In some instances, the user can move a cursor in the camera view 124 and, for each position the user moves the cursor to in the camera view 124, the location query subsystem 116 determines, using the PCS 105, LOI coordinates 107 for the current cursor position for display in the camera view 124 and the slide scanning device 120 displays the current cursor position LOI coordinates 107 in the camera view 124.

The slide scanning device 120, including the slide fiducial identification subsystem 112, the coordinates generation subsystem 114, and the location query subsystem 116, may be implemented using software (e.g., code, instructions, program) executed by one or more processing devices (e.g., processors, cores), hardware, or combinations thereof. The software may be stored on a non-transitory storage medium (e.g., on a memory component). The computing environment 100 depicted in FIG. 1 is merely an example and is not intended to unduly limit the scope of claimed embodiments. One of the ordinary skill in the art would recognize many possible variations, alternatives, and modifications. For example, in some implementations, the slide scanning device 120 can be implemented using more or fewer systems or subsystems than those shown in FIG. 1, may combine two or more subsystems, or may have a different configuration or arrangement of the systems or subsystems.

### Examples of Computer-Implemented Operations for Generating a Primary Coordinate System (PCS) for Digital-Image-Based Analysis of a Slide Based on Two or More Fiducials of the Slide Detected Within an Image of the Slide And Generating Coordinates for a Location of Interest (LOI) on the Slide Selected in the Image Based on the PCS

In the embodiments described herein, digital pathology system 110 can generate a PCS 105 for an image 104 depicting a slide 101 In some instances, the image 104 depicting the slide is a frame captured in a camera view 124 of the slide 101. The PCS 105 can enable determination of absolute coordinates 107 for any LOI 106 of the slide 101 selected in the image 104 (or selected in the camera view 124). The PCS 105, which is used to define the LOI coordinates 107, do not vary according to which slide scanning device 120 is used to view the slide 101, according to how the user registers or otherwise positions the slide 101 to the slide scanning device 120, or according to how the image 104 and/or camera view 124 of the slide is captured (e.g. camera zoom level, position, and orientation, etc.).

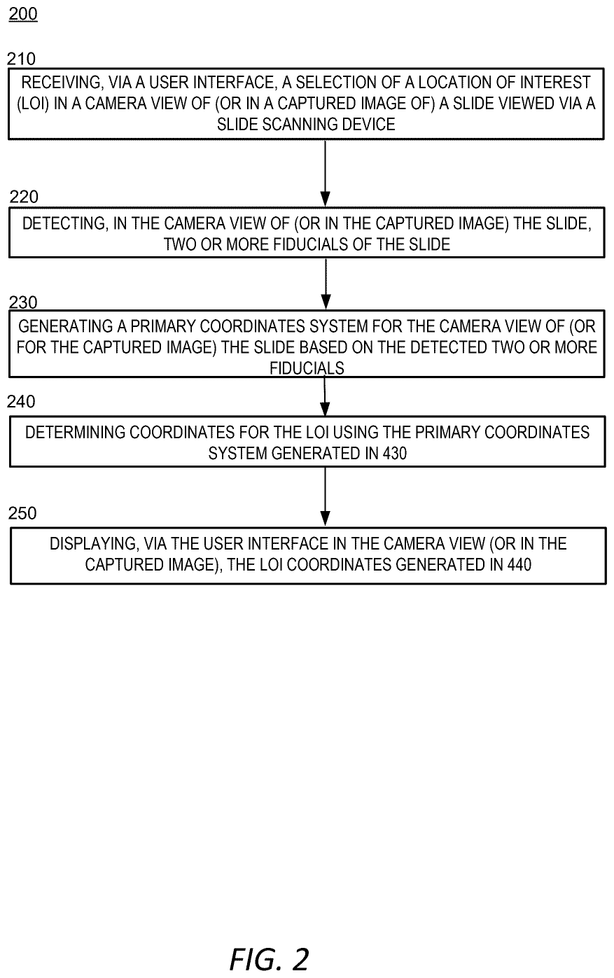

FIG. 2 depicts a method 200 for generating a primary coordinate system (PCS) 105 for digital-image-based analysis of a slide 101 based on two or more fiducials 102 of the slide 101 detected within an image 104 of the slide and generating coordinates 107 for a location of interest (LOI) 106 on the slide 101 selected in the image 104 based on the PCS 105, according to certain embodiments disclosed herein. One or more computing devices (e.g., the slide scanning device 120 or the individual subsystems contained therein) implement operations depicted in FIG. 2. For illustrative purposes, the method 200 is described with reference to certain examples depicted in the figures. Other implementations, however, are possible.

At block 210, the method 200 involves receiving, by a digital pathology system 110 via a user interface 123, a selection of a location of interest (LOI) 106 in a camera view 124 of a slide 101 viewed via a slide scanning device 120. For example, a user registers the slide 101 to a slide scanning device 120, for example, a microscope device. In some instances, registering the slide 101 to the slide scanning device 120 involves placing a drop of water to suspend a specimen between the slide 101 and a cover slip and then placing the prepared slide 101 on a stage of the slide scanning device 120. Other methods of registering the slide 101 to the slide scanning device 120 may be used. In certain examples, the LOI 106 comprises a region of interest (e.g. a region of a tissue sample) on the slide 101. The slide scanning device 120 captures, via a camera/scanning module 127, the camera view 124 of the slide 101 and displays the camera view 124 via a user interface 123 of the slide scanning device 120 or via a user interface of another device (e.g. a user computing device) communicatively coupled to the slide scanning device 120. In some instances, the slide scanning device 120 displays an image 104 of the slide 101 captured via the camera/scanning module 127.

In some instances, to select the LOI 106, the user selects, via the user interface 123 within the camera view 124, a point or area of the camera view 124 corresponding to the LOI 106 on the slide 101. For example, the user wants to locate a particular region of tissue on the slide 101 and selects, within the camera view 124, a point or area corresponding to the particular region. For example, the user can define, via the user interface 123, a LOI 106 by defining two corners of a rectangular region, defining a center and radius of a circular region, or by selecting a single point corresponding to a pixel within the camera view 124 of the slide 101 or within a captured image 104 of the slide 101. The digital pathology system 110 receives the selection of the LOI 106 input via the user interface 123 of the slide scanning device 120. In some instances, the digital pathology system 110 automatically (e.g. without receiving a manual selection) detects a point or area of the camera view 124 corresponding to the LOI 106 on the slide 101. For example, the digital pathology system 110 applies one or more object recognition models to the camera view 124 of the slide 101 (or to a frame of the camera view 124 of the slide 101 or to an image 104 captured of the slide 101) to detect the LOI 106. In some instances, the LOI 106 may comprise an abnormal area of tissue in a tissue sample that differs in one or more characteristics from tissue outside of the abnormal area. In some instances, the LOI 106 can comprise a recognized object or region of a sample (either manually selected via the user interface 124 or recognized automatically by the digital pathology system 110 via an object recognition model).

In certain embodiments, the digital pathology system 110 performs block 210 prior to blocks 220 and 230, as depicted in FIG. 1. In certain embodiments, the digital pathology system 110 performs block 210 after performing blocks 220 and 230. For example, the digital pathology system 110, in some instances, first detects two or more fiducials 102 of the slide 101 in the camera view 124 or image 104 of the slide 101 and generates the PCS 105 based on the two or more detected fiducials 102 before receiving a selection, via the user interface 123, of the LOI 106 of the slide 101 in the camera view 124 or in the image 104.

At block 220, the method 200 involves detecting, in the camera view 124 of (or in the captured image 104 of) the slide 101, two or more fiducials 102 of the slide 101. For example, the fiducials 102 can be one or more corners of the slide 101 that are detectable in the camera view 124 of (or in the captured image 104 of) the slide 101. In some instances, a fiducial 102 can be a feature of the slide 101 (e.g. a corner, a mark, an indentation) or a feature of a cover element (e.g. a corner of or marking of a cover glass) affixed to the slide that is identifiable in the camera view 124 or in the image 104. In some instances, the fiducial 102 is a high precision landmark point appropriate for use as a measurement coordinate landmark that can be easily and reliably located and identified in the image 104 or camera view 124. In some instances, a fiducial 102 can be a feature of a specimen on the slide 101. Fiducials 102 of the slide 101 detected in the camera view 124 or in the image 104 can provide a basis for generating the PCS 105 system for defining LOI coordinates 107 for one or more selected LOIs 106 on the slide. In some instances, the digital pathology system applies one or more machine learning models (e.g. image feature recognition models) to a frame of the live camera view 124 of the slide 101 or to a captured image 104 of the slide 101 to identify the fiducials 102. For example, for fiducials 102 comprising a corner of the slide, the digital pathology system 110 can apply a corner recognition model to the frame of the live camera view 124 or to the captured image 104 to identify corner fiducials 102 of the slide 101 detected in the live camera view 124 or in the image 104. In some instances, for fiducials 102 comprising particular markings on a slide 101, the digital pathology system 110 can apply an object recognition model to the frame of the live camera view 124 or to the captured image 104 to recognize fiducials 102 comprising the particular markings. In some instances, the digital pathology system 110 detects or otherwise determines two or more fiducials 102 of the slide 101 that are suitable for determining a precise anchor point for determining the PCS 105.

In some instances, the digital pathology system 110 defines, for the image 104 or camera view 124, metadata comprising coarse coordinates locating the two or more fiducials 102 detected within a low resolution image 104 or camera view 124 of the slide 101. The defined metadata of the image 104 or of the camera view 124, in some instances, indicate how the low resolution scan is registered to the object. For example, the digital pathology system 110 extracts, from metadata of an image 104 or camera view 124 of a microscope slide 101, information describing the image 104 or camera view 124 as being of the whole slide in landscape orientation, label to left, and cover glass on top with cartesian coordinates used, and the anchor point (origin) defined at the south-west (bottom left) of the slide. In some instances, the digital pathology system 110 locates data suitable for verifying the two or more fiducials 102 have been located, for example, a high resolution scan of a respective small region surrounding each of the two or more detected fiducials 102, a description of the two or more fiducials 102 verifiable by a specified algorithm, a code snippet, or a set of key parameters. For example, a particular fiducial 102 of the two or more fiducials 102 is defined as being the “north-west” (top left) corner of a cover glass on a slide and is defined in the metadata as a “Type #3 fiducial” and includes a high-resolution point of interest in the fiducial as an intersection of a pair of perpendicular lines, each drawn along the length of cover glass edges in the captured image 104 or camera view 124 by a specified algorithm at a specified lens and focus setting of the slide scanning device 120. For example, the setting comprises settings such that a top surface of the cover glass is in sharpest focus.

At block 230, the method 200 involves generating a primary coordinates system (PCS) 105 for the camera view 124 of (or for the captured image 104 of) the slide 101 based on the detected two or more fiducials 102. For example, the digital pathology system 110 determines the PCS 105 for the camera view 124 or captured image 104 of the slide 101 based on the two or more fiducials detected in the frame of the camera view 124 or in the captured image 104. Determining the PCS 105 can involve determining an origin (e.g. anchor point) for x and y axes of the PCS 105 and a scale for the x and y axes of the PCS 105, based on the detected two or more slide fiducials 102. In some instances, the digital pathology system determines distance offsets (x, y) from an anchor point and a rotational offset (θ) of each pixel of a sampling pixel grid of a scanned region of interest within the camera view 124 or within the image 104. In some instances, the digital pathology system 110 determines a two-dimensional (2D) vector (in a plane of the PCS 105) offset of a scanned pixel relative to the PCS 105 origin (anchor point). In some instances, the digital pathology system 110 performs a coordinate frame transform mathematical operation from scanned pixel coordinates to PCS 105 coordinates.

In some instances, the digital pathology system 110 stores the coordinates for each pixel of the region of interest as metadata of the camera view 124 of the slide 101 or as metadata of the image 104 of the slide 101. In some instances, each pixel of the camera view 124 (or each pixel of a captured image 104) is associated with a respective coordinate defined by respective x and y offsets (along x and y axes) and respective rotational offset θ determined from the PCS 105. The digital pathology system 110 defines a scale for each of the x and y axes corresponding to absolute distance on the slide 101. The digital pathology system 110 can associate the x-axis offset, y-axis offset, and rotational (θ) offset of each of the pixels scanned from each region of interest (e.g. a region depicting the slide), as metadata. Further, the digital pathology system 110 can associate the PCS 105 axis scale units with scanned region metadata, which enables translation between any canned pixel coordinate frame and the PCS 105 coordinate frame.

In some instances, the digital pathology system 110 stores, in association with the image 104 or the camera view 124 of the slide 101, metadata required to locate, verify, and locate the fiducials 102 as metadata. This metadata is shared for all regions of interest scanned from a single slide. In some instances, the digital pathology system 110 stores the metadata once and can reference it from each scanned region's data set. In some instances, the digital pathology system 110 stores the metadata directly as metadata associated with each scanned region of the image 104 or the camera view 124 (e.g. duplicate storage), where such a storage scheme allows the scanned data for a region, plus associated metadata, to be independently usable without following a linked reference to additional information.

In an example, the slide 101 comprises a microscope slide case and the digital pathology system 110 detects north-west and south-west cover glass corners in an image 104 or camera view 124 of the microscope slide case as fiducials 102 to generate the PCS 105. In the generated PCS 105 of this example, the digital pathology system 110 defines the south-west cover glass corner fiducial 102 as an origin (anchor point) and the y-axis of the PCS 105 extends from the south-west cover glass corner fiducial 102 to the northwest cover glass corner fiducial 102. In this example, the x-axis of the PCS 105 X axis extends through the south-west cover glass corner fiducial 102, perpendicular to the Y axis. Accordingly, as this example illustrates, the methods described herein accommodate establishing a PCS 105 for a slide including a cover glass that does not have straight edges or perpendicular sides, because the PCS 105 is defined in this example by fiducials 102 corresponding to corners of the cover glass.

At block 240, the method 200 involves determining, by the digital pathology system 110, coordinates 107 for the location of interest (LOI) 106 using the PCS 105 generated at block 230. In some instances, the digital pathology system 110 identifies a pixel associated with the LOI 106 on the slide 101 selected (e.g. selected at block 210) in the camera view 124 or in the image 104 of the slide 101. For example, the pixel defines an LOI 106 comprising a point on the slide 101. In some instances, the LOI 106 comprises an area on the slide 101 (e.g. rectangular area, a circular area) depicted by multiple pixels in the camera view 124 or in the image 104 of the slide 101. For example, the LOI 106 comprising a rectangular area on the slide 101 can be defined by coordinates associated with a first pixel depicting a corner of a rectangular area LOI (e.g. defined by an x offset, y offset, and rotational offset associated with the first pixel in the image metadata) and coordinates associated with a second pixel (e.g. defined by an x offset, y offset, and rotational offset associated with the second pixel in the image metadata) depicting an opposite corner of the rectangular area LOI 106. For example, the LOI 106 comprising a circular area on the slide can be defined PCS 105 coordinates associated with a pixel (e.g. defined by an x offset, y offset, and rotational offset associated with the pixel in the image metadata) depicting a center of a circular area LOI 106 and a set of pixels depicting the circular area LOI 106 falling within a radius of the center. In some instances, the digital pathology system 110 accesses the metadata associated with the image or camera view depicting the LOI 106 on the slide and determines the absolute PCS 105 coordinates of one or more of the one or more pixels within the image or camera view that depict the LOI 106 of the slide 101. For example, the coordinates in the PCS 105 of a pixel defining the LOI 106 comprise x and y offsets of x=−3 cm, y=+4 cm, respectively, and a rotational offset of θ=+2 degrees. In some instances, the LOI coordinates 107 can define an exact location or region on the physical slide corresponding to the pixel(s) in the camera view or image of the slide that depict the LOI 105.

At block 240, the method 200 involves displaying, by the digital pathology system 110 in the camera view 124, the LOI coordinates 107 determined at block 240. In some instances, the digital pathology system 110 displays, via the user interface 123 in the camera view 124, the determined LOI coordinates 107 responsive to receiving the selection of the LOI 106 in the camera view 124 or in the image 104 of the slide 101. In some instances, the digital pathology system 110 displays a user interface object at the LOI 106 in the camera view 124 or in the image 104 of the slide 101 to indicate the LOI 106 in the camera view 124 of the slide 101 or in the image 104 of the slide 101.

### Examples of Computing Environments for Implementing Certain Embodiments

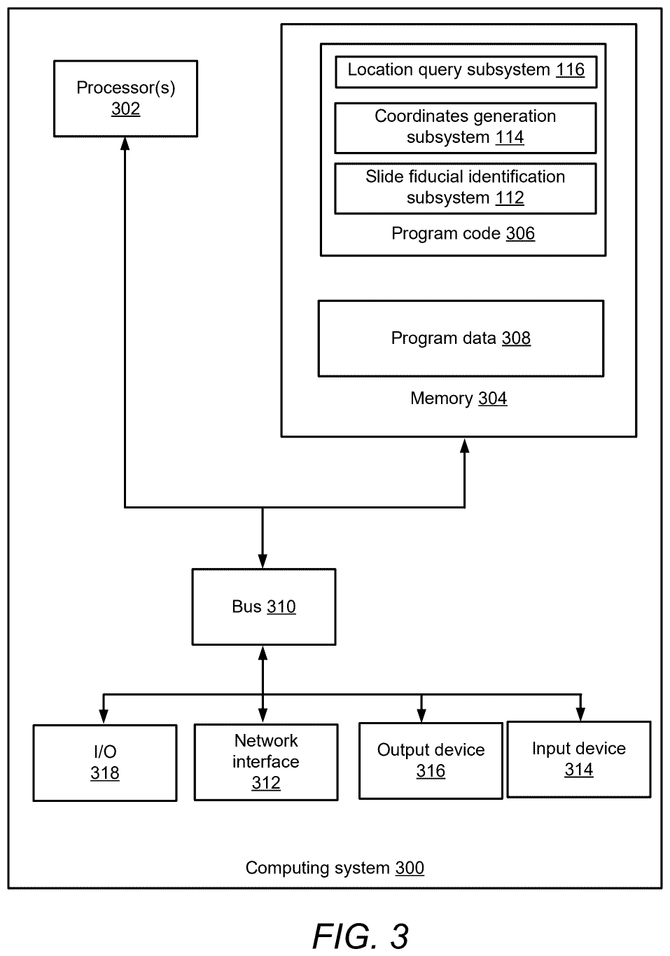

Any suitable computer system or group of computer systems can be used for performing the operations described herein. For example, FIG. 3 depicts an example of a computer system 300. The depicted example of the computer system 300 includes a processing device 302 communicatively coupled to one or more memory components 304. The processing device 302 executes computer-executable program code stored in a memory components 304, accesses information stored in the memory component 304, or both. Execution of the computer-executable program code causes the processing device to perform the operations described herein. Examples of the processing device 302 include a microprocessor, an application-specific integrated circuit (“ASIC”), a field-programmable gate array (“FPGA”), or any other suitable processing device. The processing device 302 can include any number of processing devices, including a single processing device.

The memory components 304 includes any suitable non-transitory computer-readable medium for storing program code 306, program data 308, or both. A computer-readable medium can include any electronic, optical, magnetic, or other storage device capable of providing a processing device with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript. In various examples, the memory components 1204 can be volatile memory, non-volatile memory, or a combination thereof.

The computer system 300 executes program code 306 that configures the processing device 302 to perform one or more of the operations described herein. Examples of the program code 306 include, in various embodiments, the digital pathology system 110 (including the slide fiducial identification subsystem 112, the coordinates generation subsystem 114, and the location query subsystem 116) of FIG. 1, which may include any other suitable systems or subsystems that perform one or more operations described herein (e.g., one or more neural networks, encoders, attention propagation subsystem and segmentation subsystem). The program code 1206 may be resident in the memory components 304 or any suitable computer-readable medium and may be executed by the processing device 302 or any other suitable processor.

The processing device 302 is an integrated circuit device that can execute the program code 306. The program code 306 can be for executing an operating system, an application system or subsystem, or both. When executed by the processing device 302, the instructions cause the processing device 302 to perform operations of the program code 306. When being executed by the processing device 302, the instructions are stored in a system memory, possibly along with data being operated on by the instructions. The system memory can be a volatile memory storage type, such as a Random Access Memory (RAM) type. The system memory is sometimes referred to as Dynamic RAM (DRAM) though need not be implemented using a DRAM-based technology. Additionally, the system memory can be implemented using non-volatile memory types, such as flash memory.

In some embodiments, one or more memory components 304 store the program data 1208 that includes one or more datasets described herein. In some embodiments, one or more of data sets are stored in the same memory component (e.g., one of the memory components 304). In additional or alternative embodiments, one or more of the programs, data sets, models, and functions described herein are stored in different memory components 304 accessible via a data network. One or more buses 310 are also included in the computer system 300. The buses 310 communicatively couple one or more components of a respective one of the computer system 300.

In some embodiments, the computer system 300 also includes a network interface device 312. The network interface device 312 includes any device or group of devices suitable for establishing a wired or wireless data connection to one or more data networks. Non-limiting examples of the network interface device 312 include an Ethernet network adapter, a modem, and/or the like. The computer system 300 is able to communicate with one or more other computing devices via a data network using the network interface device 312.

The computer system 300 may also include a number of external or internal devices, an input device 314, a presentation device 316, or other input or output devices. For example, the computer system 300 is shown with one or more input/output (“I/O”) interfaces 318. An I/O interface 318 can receive input from input devices or provide output to output devices. An input device 314 can include any device or group of devices suitable for receiving visual, auditory, or other suitable input that controls or affects the operations of the processing device 302. Non-limiting examples of the input device 314 include a touchscreen, a mouse, a keyboard, a microphone, a separate mobile computing device, etc. A presentation device 316 can include any device or group of devices suitable for providing visual, auditory, or other suitable sensory output. Non-limiting examples of the presentation device 316 include a touchscreen, a monitor, a speaker, a separate mobile computing device, etc.

Although FIG. 3 depicts the input device 314 and the presentation device 316 as being local to the computer system 300, other implementations are possible. For instance, in some embodiments, one or more of the input device 314 and the presentation device 316 can include a remote client-computing device that communicates with computing system 300 via the network interface device 312 using one or more data networks described herein.

Embodiments may comprise a computer program that embodies the functions described and illustrated herein, wherein the computer program is implemented in a computer system that comprises instructions stored in a machine-readable medium and a processing device that executes the instructions to perform applicable operations. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computer systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

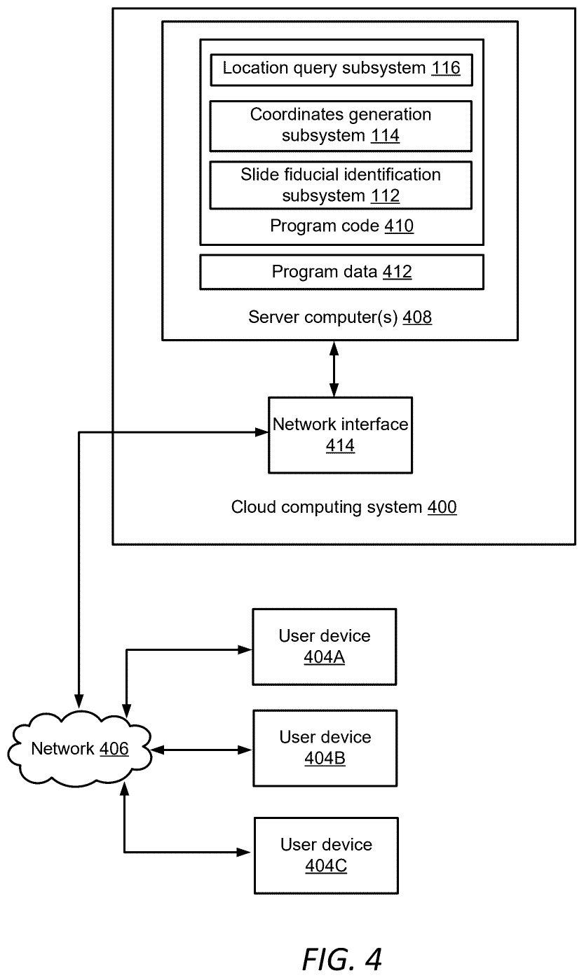

In some embodiments, the functionality provided by computer system 300 may be offered as cloud services by a cloud service provider. For example, FIG. 4 depicts an example of a cloud computer system 400 offering a service for generating a PCS 105 for an image 104 of or camera view 124 of a slide 101 based on two or more fiducials 102 of the slide detected in the image 104 or in the camera view 124 and providing coordinates 107 for a selected LOI 106 in the image 104 or the camera view 124, that can be used by a number of user subscribers using user devices 404A, 404B, and 404C across a data network 406. The cloud computer system 400 performs the processing to provide the service for generating a PCS 105 for an image 104 of or camera view 124 of a slide 101 based on two or more fiducials 102 of the slide detected in the image 104 or in the camera view 124 and providing coordinates 107 for a selected LOI 106 in the image 104 or the camera view 124. The cloud computer system 400 may include one or more remote server computers 408.

The remote server computers 408 include any suitable non-transitory computer-readable medium for storing program code 410 (e.g., slide fiducial identification subsystem 112, the coordinates generation subsystem 114, and the location query subsystem 116 of FIG. 1) and program data 412, or both, which is used by the cloud computer system 400 for providing the cloud services. A computer-readable medium can include any electronic, optical, magnetic, or other storage device capable of providing a processing device with executable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript. In various examples, the server computers 408 can include volatile memory, non-volatile memory, or a combination thereof.

One or more of the server computers 408 execute the program code 410 that configures one or more processing devices of the server computers 408 to perform one or more of the operations that execute a service for generating a PCS 105 for an image 104 of or camera view 124 of a slide 101 based on two or more fiducials 102 of the slide detected in the image 104 or in the camera view 124 and providing coordinates 107 for a selected LOI 106 in the image 104 or the camera view 124. As depicted in the embodiment in FIG. 4, the one or more servers providing the service for generating a PCS 105 for an image 104 of or camera view 124 of a slide 101 based on two or more fiducials 102 of the slide detected in the image 104 or in the camera view 124 and providing coordinates 107 for a selected LOI 106 in the image 104 or the camera view 124 may implement the slide fiducial identification subsystem 112, the coordinates generation subsystem 114, and the location query subsystem 116. Any other suitable systems or subsystems that perform one or more operations described herein (e.g., one or more development systems for configuring an interactive user interface) can also be implemented by the cloud computer system 400.

In certain embodiments, the cloud computer system 400 may implement the services by executing program code and/or using program data 412, which may be resident in a memory component of the server computers 408 or any suitable computer-readable medium and may be executed by the processing devices of the server computers 408 or any other suitable processing device.

In some embodiments, the program data 412 includes one or more datasets and models described herein. In some embodiments, one or more of data sets, models, and functions are stored in the same memory component. In additional or alternative embodiments, one or more of the programs, data sets, models, and functions described herein are stored in different memory components accessible via the data network 406.

The cloud computer system 400 also includes a network interface device 414 that enable communications to and from cloud computer system 400. In certain embodiments, the network interface device 414 includes any device or group of devices suitable for establishing a wired or wireless data connection to the data networks 406. Non-limiting examples of the network interface device 414 include an Ethernet network adapter, a modem, and/or the like. The service for generating a PCS 105 for an image 104 of or camera view 124 of a slide 101 based on two or more fiducials 102 of the slide detected in the image 104 or in the camera view 124 and providing coordinates 107 for a selected LOI 106 in the image 104 or the camera view 124 is able to communicate with the user devices 404A, 404B, and 404C via the data network 406 using the network interface device 414.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included within the scope of claimed embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computer system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Additionally, the use of “based on” is meant to be open and inclusive, in that, a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method, comprising:
receiving, by one or more computing devices via a user interface, a selection of a location in a camera view of a slide captured by the slide scanning device, the selected location in the camera view depicting a location of interest (LOI) on the slide;
detecting, by the one or more computing devices, two or more fiducials of the slide depicted in the camera view;
generating, by the one or more computing devices and based on locations within the camera view of the two or more detected fiducials, a primary coordinates system (PCS);
determining, by the one or more computing devices using the PCS, coordinates defining the location selected in the camera view, wherein the coordinates define a position of the LOI on the slide; and
displaying, in the camera view responsive to receiving the selection, the determined coordinates.

2. The computer-implemented method of claim 1, wherein the two or more fiducials comprise two or more of a corner of the slide, a corner of a cover of the slide, a marking on the slide, or a marking on the cover of the slide.

3. The computer-implemented method of claim 1, wherein generating the PCS comprises defining a respective coordinate associated with each pixel of a set of pixels of a region of interest of the camera view depicting the slide and wherein determining the coordinates associated with the selected location in the camera view comprises accessing a particular respective coordinate associated with a pixel depicting the selected location in the camera view.

4. The computer-implemented method of claim 3, wherein the region of interest in the camera view comprises a set of pixels of the camera view depicting the slide.

5. The computer-implemented method of claim 3, wherein generating the PCS comprises identifying, based on the detected two or more fiducials within the camera view, an anchor point of the slide within the camera view, wherein defining the respective coordinate comprises defining a respective x-axis offset from the anchor point, a respective y-axis offset from the anchor point, and a rotational offset.

6. The computer-implemented method of claim 1, wherein the coordinates defining the selected location in the camera view using the PCS comprise one or more offsets from an anchor point of the slide.

7. The method of claim 1, wherein the user interface comprises a user interface of the slide scanning device.

8. The method of claim 1, wherein the user interface comprises a user interface of a user computing device, wherein the user computing device is separate from the slide scanning device.

9. The method of claim 1, wherein the slide scanning device comprises a microscope, wherein the slide is registered to a stage of the microscope, and wherein the camera view comprises a view of a camera of the microscope.

10. A system comprising:
a memory component; and
a processing device coupled to the memory component, the processing device to perform operations comprising:
detecting, in a camera view of a slide captured by a slide scanning device, two or more fiducials of the slide depicted in the camera view;
generating, based on locations within the camera view of the two or more detected fiducials, a primary coordinates system (PCS);
determining, using the PCS, coordinates defining a location identified in the camera view, wherein the coordinates define a location of interest (LOI) on the slide; and
displaying, in the camera view, the determined coordinates.

11. The system of claim 10, the operations further comprising receiving, via a user interface, a selection of the location in the camera view.

12. The system of claim 10, wherein the two or more fiducials comprise two or more of a corner of the slide, a corner of a cover of the slide, a marking on the slide, or a marking on the cover of the slide.

13. The system of claim 10, wherein generating the PCS comprises defining a respective coordinate associated with each pixel of a set of pixels of a region of interest of the camera view depicting the slide and wherein determining the coordinates associated with the identified location in the camera view comprises accessing a particular respective coordinate associated with a pixel depicting the identified location in the camera view.

14. The system of claim 13, wherein generating the PCS comprises identifying, based on the detected two or more fiducials within the camera view, an anchor point of the slide within the camera view, wherein defining the respective coordinate comprises defining a respective x-axis offset from the anchor point, a respective y-axis offset from the anchor point, and a rotational offset.

15. The system of claim 13, wherein the region of interest in the camera view comprises a set of pixels of the camera view depicting the slide.

16. The system of claim 10, wherein the coordinates defining the location in the camera view using the PCS comprise one or more offsets from an anchor point of the slide.

17. A non-transitory computer-readable medium storing executable instructions, which when executed by a processing device, cause the processing device to perform operations comprising:
detecting, in a camera view of a slide captured by a slide scanning device, two or more fiducials of the slide depicted in the camera view;
generating, based on locations within the camera view of the two or more detected fiducials, a primary coordinates system (PCS), comprising defining a respective coordinate associated with each pixel of a set of pixels of a region of interest of the camera view depicting the slide;
receiving, via a user interface, a selection of a location in the camera view identifying a location of interest (LOI) on the slide depicted at the selected location in the camera view;
accessing a particular defined coordinate associated with a pixel corresponding to the selected location in the camera view; and
displaying, in the camera view responsive to receiving the selection, the accessed particular defined coordinate.

18. The non-transitory computer-readable medium of claim 17, the two or more fiducials comprise two or more of a corner of the slide, a corner of a cover of the slide, a marking on the slide, or a marking on the cover of the slide.

19. The system of claim 17, wherein generating the PCS comprises identifying, based on the detected two or more fiducials within the camera view, an anchor point of the slide within the camera view, wherein defining the respective coordinate comprises defining one or more offsets with respect to the determined anchor point.

20. The system of claim 19, wherein the one or more offsets comprise one or more of a an x-axis offset, a y-axis offset, and a rotational offset.
